(19) United States
(12) Patent Application Publication
(10) Pub. No.: US 2014/0261709 A1
(43) Pub. Date: Sep. 18, 2014

(54) CONTROL RELIABLE PNEUMATIC ENERGY ISOLATION VALVE WITH SOFT START FUNCTION

(71) Applicant: Ross Operating Valve Company, Troy, MI (US)

(72) Inventor: Richard J. Frazier, Eastanollee, GA (US)

(73) Assignee: Ross Operating Valve Company, Troy, MI (US)

(21) Appl. No.: 14/207,799

(22) Filed: Mar. 13, 2014

Related U.S. Application Data
(60) Provisional application No. 61/791,103, filed on Mar. 15, 2013.

(51) Int. Cl. F16K 31/12

(52) U.S. Cl. CPC F16K 31/12
USPC 137/1; 137/489.5

(57) ABSTRACT

A valve assembly includes a valve including an inlet and an outlet, and a soft start valve in a normally closed position and located upstream of the valve. The soft start valve opens when a percentage of an outlet pressure at the outlet of the valve to an inlet pressure of the inlet of the valve reaches a predetermined percentage to allow fluid to flow through the soft start valve to the valve.

### REFERENCE TO RELATED APPLICATIONS

This application claims priority to U.S. Provisional Patent Application No. 61/791,103 filed Mar. 15, 2013.

### BACKGROUND OF THE INVENTION

Solenoid operated control reliable pneumatic energy isolation valves are commonly employed in machinery safety applications as the main air entry valve. If full pneumatic pressure is applied immediately upon energizing the control reliable pneumatic energy isolation valve, the equipment or devices of the machinery safety applications could be damaged.

### SUMMARY OF THE INVENTION

A valve assembly according to an exemplary embodiment of this disclosure, among other possible things includes a valve including an inlet and an outlet, and a soft start valve in a normally closed position and located upstream of the valve. The soft start valve opens when a percentage of an outlet pressure at the outlet of the valve to an inlet pressure of the inlet of the valve reaches a predetermined percentage to allow fluid to flow through the soft start valve to the valve.

In a further embodiment of any of the foregoing valve assemblies, the valve is a pneumatic energy isolation valve.

In a further embodiment of any of the foregoing valve assemblies, the soft start valve is a 2-ported and 2-position valve.

In a further embodiment of any of the foregoing valve assemblies, a resilient member maintains the soft start valve in the normally closed position.

In a further embodiment of any of the foregoing valve assemblies, includes an adjustable bypass line and a non-adjustable bypass line that both bypass the soft start valve and are connected in parallel. The fluid flows through the adjustable bypass line and the non-adjustable bypass line when the soft start valve is in the normally closed position to the inlet.

In a further embodiment of any of the foregoing valve assemblies, the fluid flows through the non-adjustable bypass line has a minimum bypass flow rate.

In a further embodiment of any of the foregoing valve assemblies, the minimum bypass flow rate provides a pilot supply pressure required to actuate the valve.

In a further embodiment of any of the foregoing valve assemblies, an internal pressure line connects the outlet of the valve to an actuation piston of the soft start valve, and when the predetermined percentage is reached, pressure compresses the resilient member to fully open the soft start valve and allow the fluid to flow through the soft start valve to the valve.

In a further embodiment of any of the foregoing valve assemblies, the predetermined percentage of the outlet pressure to the inlet pressure is about 60%.

In a further embodiment of any of the foregoing valve assemblies, a volume of air is located on a line in fluid communication with the inlet of the valve to accommodate for a pressure drop when the soft start valve opens.

A valve assembly according to an exemplary embodiment of this disclosure, among other possible things includes a valve including an inlet and an outlet, and a soft start valve in a normally closed position and located upstream of the valve. A resilient member maintains the soft start valve in the normally closed position. The soft start valve opens when a percentage of an outlet pressure at the outlet of the valve to an inlet pressure of the inlet of the valve reaches a predetermined percentage to allow fluid to flow through the soft start valve to the valve. An adjustable bypass line bypasses the soft start valve. A non-adjustable bypass line bypasses the soft start valve and is connected in parallel with the adjustable bypass line. The fluid flows through the adjustable bypass line and the non-adjustable bypass line when the soft start valve is in the normally closed position to the inlet.

In a further embodiment of any of the foregoing valve assemblies, an internal pressure line connects the outlet of the valve to an actuation piston of the soft start valve, and when the predetermined percentage is reached, pressure compresses the resilient member to fully open the soft start valve and allow the fluid to flow through the soft start valve to the valve.

In a further embodiment of any of the foregoing valve assemblies, the predetermined percentage of the outlet pressure to the inlet pressure is about 60%.

In a further embodiment of any of the foregoing valve assemblies, a volume of air is located on a line in fluid communication with the inlet to accommodate for a pressure drop when the soft start valve opens.

A method of opening a soft start valve according to an exemplary embodiment of this disclosure, among other possible things includes detecting an inlet pressure of an inlet of a valve, detecting an outlet pressure of an outlet of the valve, and opening a normally closed soft start valve when a percentage of the outlet pressure of the outlet of the valve to the inlet pressure of the inlet of the valve reaches a predetermined pressure to allow fluid to flow through the soft start valve to the valve.

### BRIEF DESCRIPTION OF THE DRAWING

The various features and advantages of the invention will become apparent to those skilled in the art from the following detailed description of the currently preferred embodiment. The drawing that accompanies the detailed description can be briefly described as follows:

FIG. 1 illustrates a schematic diagram of a soft start valve located before a control reliable pneumatic energy isolation valve.

### DETAILED DESCRIPTION OF THE PREFERRED EMBODIMENT

FIG. 1 illustrates a schematic diagram of a control reliable pneumatic energy isolation valve assembly 10 including a control reliable pneumatic energy isolation valve 12 and a soft start valve 14. The control reliable pneumatic energy isolation valve 12 can be a DM2® valve, which is sold by Ross Controls of Troy, Mich. In one example, the control reliable pneumatic energy isolation valve 12 is a Ross DM2 D\C Category 4 control reliable pneumatic energy isolation valve. However, any control reliable pneumatic energy isolation valve could be used. The control reliable pneumatic energy isolation valve 12 includes an inlet 24 that receives pressure, an outlet 28 that supplies pressure to a work device or air cylinder 34, and an exhaust 32.

The soft start valve 14 is an air operated 2-ported, 2-position valve that is placed upstream of the control reliable pneumatic energy isolation valve 12. In one example, the soft start valve 14 is located upstream of the inlet 24 of the control reliable pneumatic energy isolation valve 12. The soft start valve 14 is normally closed. A resilient member 30 maintains the soft start valve 14 in the normally closed condition. In one example, the resilient member 30 is a spring.

An adjustable bypass line 16 and a non-adjustable bypass line 18 both bypass the soft start valve 14 and are connected in parallel. The flow through the adjustable bypass line 16 can be adjusted by a customer. The flow through the non-adjustable bypass line 16 cannot be completely shut off, but has a minimum bypass flow rate. The minimum bypass flow rate provides a pilot supply pressure required to actuate the control reliable pneumatic energy isolation valve 12. The flow through the adjustable bypass line 16 can be adjusted from the minimum bypass flow rate to a higher flow rate to shorten the soft start time period.

During use, the soft start valve 14 is normally closed. The main air supply pressure travels through a line 20 and through the adjustable bypass line 16 and the non-adjustable bypass line 18. The pressure travels along a line 22 and to the inlet 24 of the control reliable pneumatic energy isolation valve 12 for actuation.

An internal pressure line 26 connects an outlet 28 of the control reliable pneumatic energy isolation valve 12 to an actuation piston (not shown) of the soft start valve 14. When an outlet pressure of the control reliable pneumatic energy isolation valve 12 reaches a predetermined percentage of an inlet pressure to the soft start valve 14, the pressure compresses the resilient member 30, and the soft start valve 14 fully opens. The soft start time period ends, and there is now full line pressure and flow available to the control reliable pneumatic energy isolation valve 12 through the line 20. When the soft start valve 14 is open, air flows through the line 20 to the inlet 24 of the control reliable pneumatic energy isolation valve 12.

In one example, the predetermined percentage of the outlet pressure to the inlet pressure is about 60%. The percentage of the outlet pressure relative to the inlet pressure is determined by the resilient member 30 in the soft start valve 14 and the force bias on the valve internals exerted by the flow media.

A volume of air 36 is located on the line 22. Before the soft start valve 14 opens, there could be a sudden pressure drop that could make the control reliable pneumatic energy isolation valve 12 unstable. The air in the volume 36 accommodates for any pressure drop.

By employing a soft start valve 14, full pneumatic pressure is not immediately applied upon energizing the control reliable pneumatic energy isolation valve 12, reducing the possibility of any damage to any equipment that the energy isolation valve 12 is provided air to. For example, the energy isolation valve 12 can be providing air to a single acting cylinder.

The soft start valve 14 does not impede or circumvent any safety functions of the control reliable pneumatic energy isolation valve 12, and therefore does not result in a de-rating of the safety rating of the control reliable pneumatic energy isolation valve 12.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A valve assembly comprising:
a valve including an inlet and an outlet; and
a soft start valve in a normally closed position and located upstream of the valve, wherein the soft start valve opens when a percentage of an outlet pressure at the outlet of the valve to an inlet pressure of the inlet of the valve reaches a predetermined percentage to allow fluid to flow through the soft start valve to the valve.

2. The valve assembly as recited in claim 1 wherein the valve is a pneumatic energy isolation valve.

3. The valve assembly as recited in claim 1 wherein the soft start valve is a 2-ported and 2-position valve.

4. The valve assembly as recited in claim 1 wherein a resilient member maintains the soft start valve in the normally closed position.

5. The valve assembly as recited in claim 1 including an adjustable bypass line and a non-adjustable bypass line that both bypass the soft start valve and are connected in parallel, wherein the fluid flows through the adjustable bypass line and the non-adjustable bypass line when the soft start valve is in the normally closed position to the inlet.

6. The valve assembly as recited in claim 5 wherein the fluid flows through the non-adjustable bypass line has a minimum bypass flow rate.

7. The valve assembly as recited in claim 6 wherein the minimum bypass flow rate provides a pilot supply pressure required to actuate the valve.

8. The valve assembly as recited in claim 1 wherein an internal pressure line connects the outlet of the valve to an actuation piston of the soft start valve, and when the predetermined percentage is reached, pressure compresses the resilient member to fully open the soft start valve and allow the fluid to flow through the soft start valve to the valve.

9. The valve assembly as recited in claim 1 wherein the predetermined percentage of the outlet pressure to the inlet pressure is about 60%.

10. The valve assembly as recited in claim 1 wherein a volume of air is located on a line in fluid communication with the inlet of the valve to accommodate for a pressure drop when the soft start valve opens.

11. A valve assembly comprising:
a valve including an inlet and an outlet;
a soft start valve in a normally closed position and located upstream of the valve, wherein a resilient member maintains the soft start valve in the normally closed position, the soft start valve opens when a percentage of an outlet pressure at the outlet of the valve to an inlet pressure of the inlet of the valve reaches a predetermined percentage to allow fluid to flow through the soft start valve to the valve;
an adjustable bypass line that bypasses the soft start valve; and
a non-adjustable bypass line that bypasses the soft start valve and is connected in parallel with the adjustable bypass line, wherein the fluid flows through the adjustable bypass line and the non-adjustable bypass line when the soft start valve is in the normally closed position to the inlet.

12. The valve assembly as recited in claim 11 wherein an internal pressure line connects the outlet of the valve to an actuation piston of the soft start valve, and when the predetermined percentage is reached, pressure compresses the resilient member to fully open the soft start valve and allow the fluid to flow through the soft start valve to the valve.

13. The valve assembly as recited in claim 11 wherein the predetermined percentage of the outlet pressure to the inlet pressure is about 60%.

14. The valve assembly as recited in claim 11 wherein a volume of air is located on a line in fluid communication with the inlet to accommodate for a pressure drop when the soft start valve opens.

15. A method of opening a soft start valve comprising the step of:
detecting an inlet pressure of an inlet of a valve;
detecting an outlet pressure of an outlet of the valve; and
opening a normally closed soft start valve when a percentage of the outlet pressure of the outlet of the valve to the inlet pressure of the inlet of the valve reaches a predetermined pressure to allow fluid to flow through the soft start valve to the valve.
